(19) United States
(12) Patent Application Publication
(10) Pub. No.: US 2008/0085219 A1
(43) Pub. Date: Apr. 10, 2008

(54) Microfluidic platform and method

(76) Inventors: David J. Beebe, Monona, WI (US); Francisco Javier Atencia-Fernandez, Bethesda, MD (US)

Correspondence Address: BOYLE FREDRICKSON S.C., 840 North Plankinton Avenue, MILWAUKEE, WI, 53203, US

(21) Appl. No.: 11/543,420

(22) Filed: Oct. 5, 2006

(51) Int. Cl. B01L 3/00

(52) U.S. Cl. 422/99

(57) ABSTRACT

A method and microfluidic platform is provided for providing a closed loop, microfluidic circulatory system having the steady flow of fluid therethrough. A first flow path is filled with a first fluid. The first flow path has an inlet and an outlet. A passageway extending through a first tube is filled with a second fluid. The passageway has first and second ends. The first end of the passageway is interconnected to the inlet of the first flow path and the second end of the passageway is interconnected to the outlet of the first flow path. A pump pumps the first and second fluids in steady flow through the first flow path and the passageway.

### FIELD OF THE INVENTION

This invention relates generally to microfluidic devices, and in particular, to a microfluidic platform and a method for providing the steady flow of fluid through a closed loop system.

### BACKGROUND AND SUMMARY OF THE INVENTION

As is known, micro (cellular) scale technology and engineering is emerging as a promising technology to facilitate biological study. Given that closed loop fluid paths such as circulatory systems are essential to many organisms, it can be appreciated that practically all of these prior attempts at providing a functional microfluidic system incorporate the continuous flow of a fluid through a channel of a microfluidic device. For example, microfluidic loops are being employed for processes that need cycling such as PCR applications, enhanced sensing e.g. exposing a sample several times to a sensor, and microfluidic controlled cell culture. Microfluidic loops, however, have specific operational challenges due to the dominant phenomena at the micro scale. More specifically, problems may arise during the controlled loading of analytes in the channel that forms the loop of the microfluidic device or when sampling the fluid within the channel of the loop. In addition, a major challenge is priming or filling the channel of a microfluidic loop in part because of the difficulties in avoiding bubble formation.

There are several approaches to avoid bubble formation when filling a microfluidic loop. In a first approach, liquid is introduced through common inlet for first and second branches of the loop. The liquid simultaneously fills both branches until it reaches the junction at a common outlet. If the liquid reaches the outlet through one of the branches first, a bubble will form in the other branch clogging the flow. At the macro scale, the tipping the branches of the loop to elevate the outlet might eliminate the bubble via gravity. However, at the micro scale, the force required to move the bubble is related to the capillary forces. Hence, in order to apply the sufficient pressure to eliminate the bubble, the pressure must be applied between the branches of the loops. Thus, the same pressure must be applied to both branches of the micro channel network. While the critical pressure in the first branch may slowly start moving the bubble, in the other branch, the same pressure would lead to large undesired flows.

An alternate approach to overcoming bubbles involves pre-filling the loop with CO₂ and then introducing the liquid. Any CO₂ bubbles formed in the loop will dissolve into the liquid. However, the dissolved CO₂ may change the pH of the liquid, which could cause an undesired side effect for some applications. A further approach for overcoming bubbles in the loop involves pressurizing both the inlet and the outlet simultaneously in order to evacuate the bubble out to atmosphere through the semi-permeable walls of a microfluidic device. However, the filling times for the loop in the microfluidic device can be as long as minutes and the approach is only valid for use in conjunction with microfluidic devices fabricated from permeable materials. A still further, alternative approach for overcoming bubbles in the loop contemplates immersing the entire microfluidic device in buffer solution and exposing the device to a vacuum for several minutes. Again, however, this approach is only valid for use in conjunction with microfluidic devices fabricated from permeable materials.

Another problem associated with the development of a functional microfluidic system pertains to the fluctuations in the flow of fluid in through the closed loop fluid path. As is known, flow fluctuations can degrade performance of several microfluidic applications. In particular, flow transients have a negative impact in mass-transfer microfluidic applications such as microfluidic separations where flow fluctuations produce cross flows between collection streams; T-sensors where flow fluctuations produce oscillations in the diffusive interface reducing sensitivity; and microfluidic fabrication, where flow fluctuations produce spatial imprecision in the deposition/etching processes. Steady flow is also important for the optimization of microfluidic systems with ‘virtual walls’ and ultra-thin walls or membranes. In these cases, the integrity of the walls is maintained under a critical pressure along the interface. Steady flow avoids transient peaks of pressure that can disrupt the critical pressure of the system breaking it. Also, in nature, steady flow has an important role in mass-transfer systems. For example, in the human circulatory system, the pump (the heart) is peristaltic and produces pulsatile flow. However, the compliance of the arteries attenuate the pulses (i.e. hydraulic filtering) thereby yielding steady flow at the capillary level where most mass-transfer processes occur.

Unlike in the human circulatory system, most microfluidic fabrication processes yield negligible compliance of the walls of the microchannels compared to that of arteries or other natural vascular conduits. With no compliance of the walls, there is no hydraulic filter to produce pulse-free now. Thus, to avoid flow fluctuations at mass-transfer regions in microfluidic systems, the pump itself must produce a steady flow. Previously, re-circulating flows have been generated in microfluidic systems by various methods including AC electrokinetic pumping and buoyancy driven pumping. Flow generation via an electric field is very sensitive to the properties of the fluids, while buoyancy driven pumping produces a thermal cycle useful for specific applications such as PCR, but is problematic in other applications.

Generally, mechanical pumping does not interfere with the properties of the fluids, but usually is associated with flow oscillations. In mass-transfer applications with open circuit (without looping), a steady flow has been generated with syringe pumps and gravity-driven pumping. However, at low flow rates, vibrations on the walls of the syringe pumps and non linear friction can induce significant oscillations. Gravity-driven pumping is usually performed with columns of liquid connected to the inlets of the microsystem. In order to overcome the difficulties associated with maintaining the columns of liquid at a constant level throughout experiments to generate steady flow, a passive gravity-based pumping mechanism that generates steady flow using horizontal capillaries has been develop. However, there still exists a need to provide an engineered closed-loop microfluidic systems with mechanically driven steady flow.

Therefore, it is a primary object and feature of the present invention to provide a microfluidic platform incorporating an engineered closed-loop microfluidic systems with mechanically driven steady flow.

It is a further object and feature of the present invention to provide a microfluidic platform incorporating a closed-loop microfluidic system that avoids bubble formation when filling the channel defining the loop.

It is a still further object and feature of the present invention to provide a method forming a closed loop, microfluidic circulatory system that incorporates the steady flow of fluid therethough.

In accordance with the present invention, a microfluidic platform is disclosed for providing a closed loop fluid path. The microfluidic platform includes a body defining a first channel therein. The first channel having an inlet and an outlet. A connector has a passageway therethrough. The passageway has a first end removeably receivable in the inlet of the first channel and a second end removeably receivable in the outlet of the first channel.

The microfluidic platform may also include a pump disposed in the first channel. The pump is movable between a first stationary position and a second operating position wherein the pump circulates fluid in the first channel and the passageway. The first channel includes an enlarged portion for housing the pump. The pump may include a rotatable disc having a stir bar operatively connected thereto. The stir bar is fabricated from a magnetically attractable material such that the stir bar rotates the disc in response to a rotating magnetic field. Alternatively, the pump may include an impeller. The impeller is rotatable in response to an external magnetic field.

It is contemplated for the body to define a second channel therein. The second channel has an inlet and an outlet. The microfluidic platform may also include a second connector having a passageway therethrough. The passageway of the second connector has a first end removeably receivable in the inlet of the second channel and a second end removeably receivable in the outlet of the second channel. The first and second channels in the body may communicate with each other.

In accordance with a further aspect of the present invention, a microfluidic platform is disclosed for providing a closed loop fluid path. The microfluidic platform includes a body defining a first channel therein The first channel has an inlet and an outlet and defines an enlarged pump cavity. A pump is disposed in the enlarged pump cavity. The pump rotates in response to a rotating magnetic field. A removable connector has a passageway therethrough. The passageway has a first end receivable in the inlet of the first channel and a second end receivable in the outlet of the first channel.

The pump may includes a rotatable disc having a stir bar operatively connected thereto. The stir bar is fabricated from a magnetically attractable material such that the stir bar rotates the disc in response to the rotating magnetic field. Alternatively, the pump may include an impeller. The impeller is rotatable in response to the rotating magnetic field.

The body may also define a second channel therein. The second channel has an inlet and an outlet. The microfluidic platform may also include a second removable connector having a passageway therethrough. The passageway of the second connector has a first end receivable in the inlet of the second channel and a second end receivable in the outlet of the second channel. The first and second channels in the body may communicate with each other.

In accordance with a still further aspect of the present invention, a method is disclosed for providing a closed loop, microfluidic circulatory system. The method includes the step of filling a first flow path with a first fluid. The first flow path has an inlet and an outlet. A passageway extending through a first tube is filled with a second fluid. The passageway has first and second ends. The first end of the passageway is interconnected to the inlet of the first flow path and the second end of the passageway is interconnected to the outlet of the first flow path. The first and second fluids is pumped through the first flow path and the passageway.

The method may also include the additional step of filling a second flow path with a third fluid. The second flow path has an inlet and an outlet. A passageway extends through a second tube and is filled with a fourth fluid. The passageway through the second tube has first and second ends. The first end of the passageway through the second tube is interconnected to the inlet of the second flow path and the second end of the passageway through the second tube is interconnected to the outlet of the second flow path. The third and fourth fluids is pumped through the second flow path and the passageway through the second tube.

The first and second flow paths are formed in a body and they may communicate. The step of pumping the first and second fluids through the first flow path and the passageway includes the additional step of mixing the first and second fluids. The mixed first and second fluids define a mixture. The method may also include the additional step of filling a second flow path with a third fluid. The second flow path has an inlet and an outlet. The first end of the passageway is disconnected from the inlet of the first flow path and the second end of the passageway is disconnected from the outlet of the second flow path. The passageway has the mixture therein. The first end of the passageway is interconnected to the inlet of the second flow path and the second end of the passageway is interconnected to the outlet of the second flow path. The method includes the additional step of pumping the third fluid and the mixture through the second flow path and the passageway.

The first flow path may include a first downstream portion and a second upstream portion. The upstream and downstream portions of the first flow path may be interconnected with a flow through droplet such that the mixture flows through the flow through droplet. A portion of the mixture flowing through the flow through droplet can be removed.

### BRIEF DESCRIPTION OF THE DRAWINGS

The drawings furnished herewith illustrate a preferred construction of the present invention in which the above advantages and features are clearly disclosed as well as others which will be readily understood from the following description of the illustrated embodiment.

In the drawings:

FIG. 1 is an exploded isometric view of a microfluidic platform for use in the method of the present invention;

FIG. 2 is an isometric view of the microfluidic platform of FIG. 1;

FIG. 3 is an isometric view of a second embodiment of a microfluidic platform for use in the method of the present invention;

FIG. 4 is an isometric view of a third embodiment of a microfluidic platform for use in the method of the present invention in a first state;

FIG. 5 is an isometric view of the third embodiment of a microfluidic platform for use in the method of the present invention in a second state;

FIG. 6 is an isometric view of a fourth embodiment of a microfluidic platform for use in the method of the present invention; and

FIG. 7 is an enlarged, isometric view showing a portion of the microfluidic platform of FIG. 6.

### DETAILED DESCRIPTION OF THE DRAWINGS

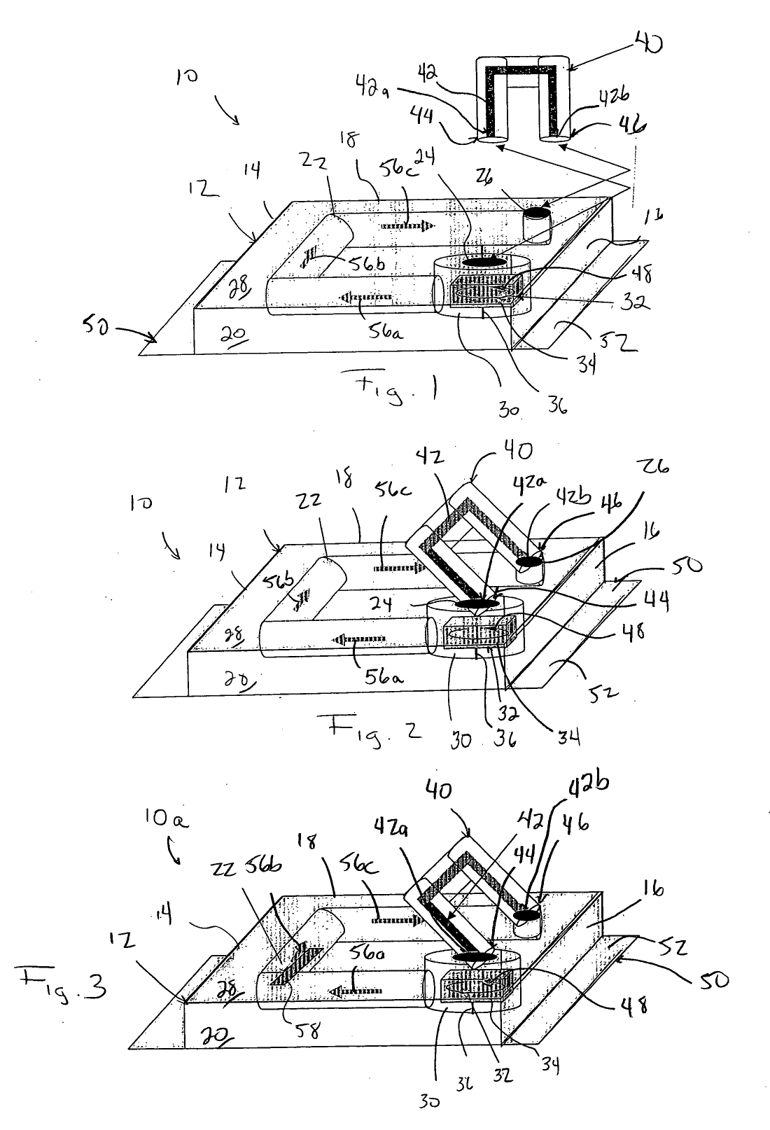

Referring to FIGS. 1-2, a mircofluidic platform in accordance with the present invention is generally designated by the reference numeral 10. Microfluidic platform 10 includes a cartridge 12 defined by first and second ends 14 and 16, respectively, and first and second sides 18 and 20, respectively. Channel 22 is provided in cartridge 12 to effectuate the method of the present invention. It can be appreciated that the configuration of channel 22 may be altered without deviating from the scope of the present invention.

As best seen in FIGS. 1-2, channel 22 is generally U-shaped and includes inlet 24 and outlet 26. Inlet 24 and outlet 26 communicate with upper surface 28 of cartridge 12. In addition, channel 22 includes an enlarged pump receiving cavity 30 that communicates with inlet 24. Pump receiving cavity 30 is adapted for receiving pump 32 therein. Pump 32 may take the form of a rotatable impeller incorporating a bar of magnetically attractable material, e.g., a ferromagnetic stainless steel bar 34. Alternatively, pump 32 make take the form of a disc pump incorporating a ferromagnetic stainless steel bar (same dimensions and material as the one used as an impeller) embedded in a polymer disc fabricated from a material such as isoobomylacrylate (IBA). It is noted that the disc may by fabricated from a ferromagnetic material such that the disc rotates in response to ferromagnetic hysteresis or from a conductive material such that the disc rotates in response to electromagnetic induction. The impeller or disc is rotatably mounted on support post 36 in axial symmetry.

Microfluidic platform 10 further includes a generally U-shaped capillary insert generally designated by the reference numeral 40. It can be appreciated that capillary insert 40 may have other shapes without deviating from the scope of the present invention. Capillary insert 40 includes an inner surface defining a channel or passageway 42 therethrough. Capillary insert 40 includes first end 44 and second end 46, for reasons hereinafter described.

In operation, channel 22 in cartridge 12 is filled with a first sample fluid. Similarly, channel 42 though capillary insert 40 is filled with a second sample fluid. The first and second sample fluids may be identical or different. In addition, the first and second fluids may incorporate particles, molecules, cells or other biological or non-biological objects. Thereafter, first end 44 of capillary insert 40 is inserted into inlet 24 of channel 22 such that channel 22 communicates with first end 42a of passageway 42 through capillary insert 40. Second end 46 of capillary insert 40 is inserted into outlet 26 of channel 22 such that channel 22 communicates with second end 42b of passageway 42 through capillary insert 40, FIG. 2. As described, capillary insert 40 connects inlet 24 and outlet 26 of channel 22 such that channel 22 and passageway 42 define a closed loop and create a circulatory system.

In order to generate the steady flow of fluid through the closed loop defined by channel 22 and passageway 42, pump 32 is rotated in a first direction as indicated by arrow 48. It is contemplated to rotate pump 32 by the application of an external magnetic field. By way of example, magnetic stirrer 50 may be used, but other types of magnetic sources such as microelectrodes or microcoils may be used without deviating from the scope of the present invention.

Magnetic stirrer 50 includes upper surface 52 for receiving microfluidic platform 10 thereon. As is conventional, magnetic stirrer 50 houses a rotatable bar magnet and includes a control device (not shown) operatively connected to the bar magnet for rotating the bar magnet about central axis at a user selected frequency. An input device such as a rotatable knob may be provided to allow a user to input the selected frequency. Upon actuation of magnetic stirrer 50, the bar magnet magnetically couples and rotates bar 34, and hence, the impeller or disc operatively connected thereto. It can be appreciated that fluid entering pump cavity 30 through the axis of post 34 is urged through channel 22 in a direction generally indicated by arrows 56a-56c due to centrifugal force. Further, since microfluidic platform 10 defines a closed loop with an integrated pump, the resistance of channel 22 and passageway 42 exert the only opposition to the fluid flow. In other words, the fluids flow through channel 22 and passageway 42 without back pressure.

Once fluids in channel 22 and passageway 42 have re-circulated several times and a mixture has been formed, capillary insert 40 may be removed from cartridge 12 with a portion of the mixture or sample contained therein. Thereafter, capillary insert 40 may be interconnected to a second cartridge, in the manner heretofore described, in order to analyze the sample or to perform a second reaction. It can be appreciated that microfluidic platform 10 solves three major problems when working with closed loop systems within microfluidic devices, namely: (1) the filling of a closed loop within a microfluidic device without bubbles; (2) the introduction of a sample into a closed loop without sample loss or dilution in connectors and tubing; and (3) the extraction of a sample and the handling it at the macro scale.

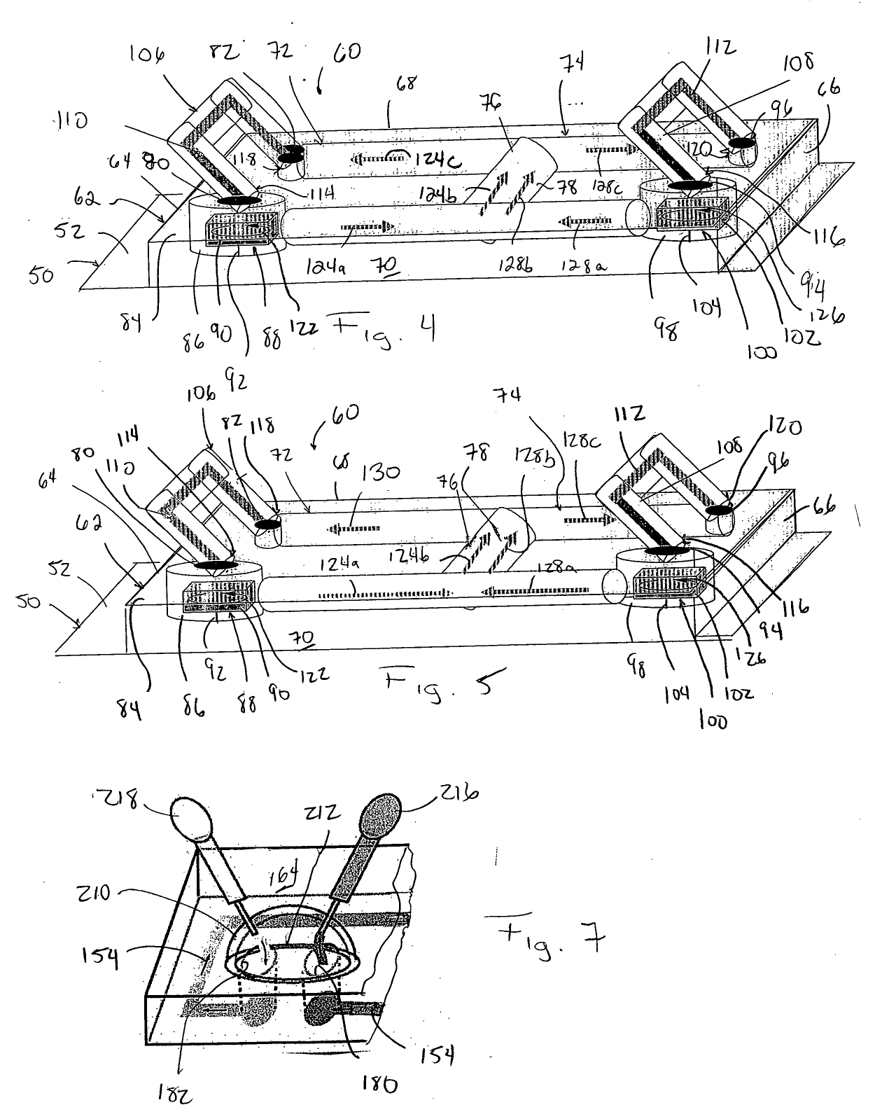

Referring to FIG. 3, an alternate embodiment of the microfluidic platform of the present invention is generally designated by the reference numeral 10a. Microfluidic platform 10a is substantially identical in structure to microfluidic platform 10. As such, the previous description of microfluidic platform 10 is understood to describe microfluidic platform 10a, except as hereinafter provided.

It is contemplated to position sensor 58 in close proximity to channel 22 in cartridge 12. Sensor 58 may take the form of an optical sensor, an enzymatic sensor, an electrostatic sensor, or the like. It can be appreciated that sensor 58 may be used to monitor a predetermined parameter of the sample flowing through channel 22.

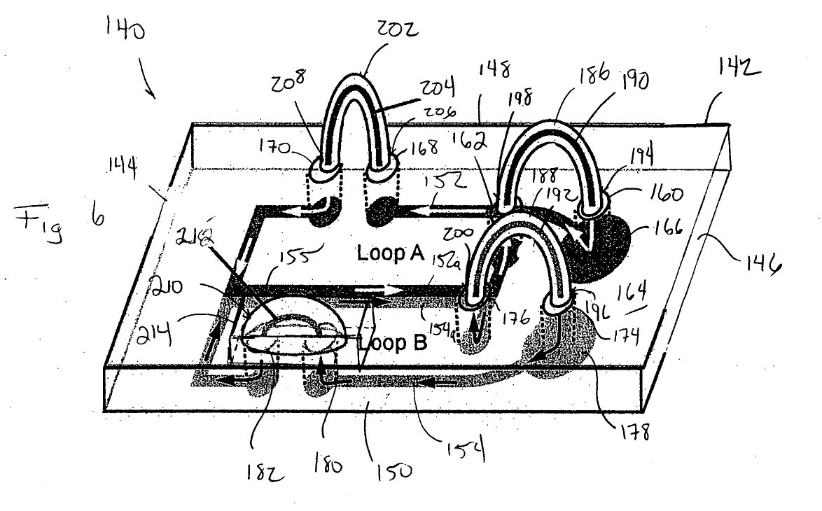

Referring to FIGS. 4-5, a still further embodiment of the microfluidic platform of the present invention is generally designated by the reference numeral 60. Microfluidic platform 60 includes cartridge 62 defined by first and second ends 64 and 66, respectively, and first and second sides 68 and 70, respectively. First and second channels 72 and 74, respectively, are provided in cartridge 62 to effectuate the method of the present invention. It can be appreciated that the configurations of channels 72 and 74 may be altered without deviating from the scope of the present invention.

Channels 72 and 74 are generally U-shaped and include central portions 76 and 78, respectively, that communicate with each other. Channel 72 includes inlet 80 and outlet 82. Inlet 80 and outlet 82 communicate with upper surface 84 of cartridge 62. In addition, channel 72 includes an enlarged pump receiving cavity 86 that communicates with inlet 80. Pump receiving cavity 86 is adapted for receiving pump 88 therein. Pump 88 may take the form of a rotatable impeller incorporating a bar of magnetically attractable material, e.g., a ferromagnetic stainless steel bar 90. Alternatively, pump 88 make take the form of a disc pump incorporating a ferromagnetic stainless steel bar (same dimensions and material as the one used as an impeller) embedded in a polymer disc fabricated from a material such as isoobornylacrylate (IBA). The impeller or disc is rotatably mounted on support post 92 in axial symmetry.

Channel 74 includes inlet 94 and outlet 96. Inlet 94 and outlet 96 communicate with upper surface 84 of cartridge 62. In addition, channel 74 includes an enlarged pump receiving cavity 98 that communicates with inlet 94. Pump receiving cavity 98 is adapted for receiving pump 100 therein. Pump 100 may take the form of a rotatable impeller incorporating a bar of magnetically attractable material, e.g., a ferromagnetic stainless steel bar 102. Alternatively, pump 100 make take the form of a disc pump incorporating a ferromagnetic stainless steel bar (same dimensions and material as the one used as an impeller) embedded in a polymer disc fabricated from a material such as isoobornylacrylate (IBA). It is noted that the disc may by fabricated from a ferromagnetic material such that the disc rotates in response to ferromagnetic hysteresis or from a conductive material such that the disc rotates in response to electromagnetic induction. The impeller or disc is rotatably mounted on support post 104 in axial symmetry.

Microfluidic platform 60 further includes first and second generally U-shaped capillary inserts 106 and 108, respectively. It can be appreciated that capillary inserts 106 and 108 may have other shapes without deviating from the scope of the present invention. Capillary inserts 106 and 108 include inner surfaces defining corresponding channels or passageways 110 and 112, respectively, therethrough. Capillary inserts 106 and 108 include first ends 114 and 116, respectively, and second ends 118 and 120, respectively, for reasons hereinafter described.

In operation, channels 72 and 74 in cartridge 62 are filled with a first sample fluid. Similarly, passageways 110 and 112 though capillary inserts 106 and 108, respectively, are filled with corresponding second and third sample fluids, respectively. The first, second and third sample fluids may be identical or different. In addition, the first, second and third fluids may incorporate particles, molecules, cells or other biological or non-biological objects. Thereafter, first end 114 of capillary insert 106 is inserted into inlet 80 of channel 72 such that channel 72 communicates with a first end of passageway 110 through capillary insert 106. Second end 118 of capillary insert 106 is inserted into outlet 82 of channel 72 such that channel 72 communicates with a second end of passageway 110 through capillary insert 106. In addition, first end 116 of capillary insert 108 is inserted into inlet 94 of channel 74 such that channel 74 communicates with a first end of passageway 112 through capillary insert 108. Second end 120 of capillary insert 108 is inserted into outlet 96 of channel 74 such that channel 74 communicates with a second end of passageway 112 through capillary insert 108. As described, capillary insert 106 connects inlet 80 and outlet 82 of channel 72 and capillary insert 108 connects inlet 94 and outlet 96 of channel 74. As such, channels 72 and 74 and passageways 110 and 112 define a closed loop and create a circulatory system.

In order to generate the steady flow of fluid through the loop defined by channel 72 and passageway 110, pump 88 is rotated in a first direction as indicated by arrow 122. It is contemplated to rotate pump 88 by the application of an external magnetic field. By way of example, magnetic stirrer 50 may be used, but other types of magnetic sources such as microelectrodes or microcoils may be used without deviating from the scope of the present invention.

Magnetic stirrer 50 includes upper surface 52 for receiving microfluidic platform 60 thereon. As is conventional, magnetic stirrer 50 houses a rotatable bar magnet and includes a control device (not shown) operatively connected to the bar magnet for rotating the bar magnet about central axis at a user selected frequency. An input device such as a rotatable knob may be provided to allow a user to input the selected frequency. Upon actuation of magnetic stirrer 50, the bar magnet magnetically couples and rotates bar 90, and hence, the impeller or disc operatively connected thereto. It can be appreciated that fluid entering pump cavity 86 through the axis of post 92 is urged through channel 72 in a direction generally indicated by arrows 124a-124c due to centrifugal force.

In order to generate the steady flow of fluid through the loop defined by channel 74 and passageway 112, pump 100 is rotated in a first direction as indicated by arrow 126. It is contemplated to rotate pump 100 by the application of an external magnetic field. By way of example, magnetic stirrer 50 may be used, but other types of magnetic sources such as microelectrodes or microcoils may be used without deviating from the scope of the present invention.

Upon actuation of magnetic stirrer 50, the bar magnet magnetically couples and rotates bar 102, and hence, the impeller or disc operatively connected thereto. It can be appreciated that fluid entering pump cavity 98 through the axis of post 104 is urged through channel 74 in a direction generally indicated by arrows 128a-128c due to centrifugal force.

Since microfluidic platform 60 defines a closed circulatory system with integrated pumps, the resistances of channel 72 and 74 and of passageways 110 and 112 exert the only opposition to the fluid flow. In other words, the fluids flow through channel 72 and passageway 110 without back pressure and through channel 74 and passageway 112 without back pressure.

Referring to FIG. 5, it is contemplated to utilize microfluidic platform 60 for the separation and collection of particles based on size. More specifically, it can be appreciated that controlled diffusion can occur at the interface of the fluid streams flowing in central portions 76 and 78 of channels 72 and 74, respectively. Diffusion across fluid streams is function of the residence time of the fluids at the interface; that is, the velocity of the streams and length of the interface. Thus, it is possible to extract different percentages of small particles just by allowing longer recirculation time. In other platforms with open circuits, longer residence time also means more time for big particles to diffuse across the interface. Here, however, the distribution of particles in one loop is reset as the fluid is mixed when it flows through the pump cavity, e.g., pump cavity. Hence, the longer recirculation time does increase the probability and total amount of small particles diffusing through the interface, but has minor effects on the diffusion of big particles.

As best seen in FIG. 5, it is contemplated to fill channels 72 and 74 and passageway 110 with one or more particle-free fluids. Passageway 112 of capillary insert 108 is filled with a sample fluid containing large and small particles. As heretofore described, first end 114 of capillary insert 106 is inserted into inlet 80 of channel 72 such that channel 72 communicates with a first end of passageway 110 through capillary insert 106. Second end 118 of capillary insert 106 is inserted into outlet 82 of channel 72 such that channel 72 communicates with a second end of passageway 110 through capillary insert 106. In addition, first end 116 of capillary insert 108 is inserted into inlet 94 of channel 74 such that channel 74 communicates with a first end of passageway 112 through capillary insert 108. Second end 120 of capillary insert 108 is inserted into outlet 96 of channel 74 such that channel 74 communicates with a second end of passageway 112 through capillary insert 108. As described, capillary insert 106 connects inlet 80 and outlet 82 of channel 72 and capillary insert 108 connects inlet 94 and outlet 96 of channel 74. As such, channels 72 and 74 and passageways 110 and 112 define a closed loop and create a circulatory system.

Magnetic stirrer is activated so as to generate steady fluid flow through the loop defined by channel 72 and passageway 110 and steady fluid flow through the loop defined by channel 74 and passageway 112. Diffusion occurs at the interface the fluid streams flowing through central portions 76 and 78 of channels 72 and 74, respectively, such that the small particles flowing in central portion 78 of channel 74 diffuse in the fluid stream flowing in central portion 76 of channel 72. As a result, the smaller particles are carried in the stream designated by the reference numeral 130 toward capillary insert 106. Once the fluids flowing in channel 72 and passageway 110 and in channel 74 and passageway 112 have been re-circulated several times and a mixture has been formed, capillary insert 106 may be removed from cartridge 62 such that the mixture contained therein contains a sample of small particles. Capillary insert 106 may be interconnected to a second cartridge, in the manner heretofore described, in order to analyze the sample or to perform a second reaction.

Referring to FIG. 6, a still further embodiment of a microfluidic platform in accordance with the present invention is generally designated by the reference numeral 140. Microfluidic platform 140 includes cartridge 142 defined by first and second ends 144 and 146, respectively, and first and second sides 148 and 150, respectively. First and second channels 152 and 154, respectively, are provided in cartridge 142 to effectuate the method of the present invention. It can be appreciated that the configurations of channels 152 and 154 may be altered without deviating from the scope of the present invention.

Channels 152 and 154 communicate along portions 152a and 154a, respectively, thereof at interface 155. Channel 152 includes inlet 160 and outlet 162. Inlet 160 and outlet 162 communicate with upper surface 164 of cartridge 142. In addition, channel 152 includes an enlarged pump receiving cavity 166 that communicates with inlet 160. Pump receiving cavity 166 is adapted for receiving a pump therein. The pump may take the form of a rotatable impeller incorporating a bar of magnetically attractable material, e.g., a ferromagnetic stainless steel bar. Alternatively, the pump may take the form of a disc pump incorporating a ferromagnetic stainless steel bar (same dimensions and material as the one used as an impeller) embedded in a polymer disc fabricated from a material such as isoobomylacrylate (IBA). The impeller or disc is rotatably mounted on a support post in axial symmetry. Channel 152 further includes upstream port 168 and downstream port 170, for reasons hereinafter described.

Channel 154 includes inlet 174 and outlet 176. Inlet 174 and outlet 176 communicate with upper surface 164 of cartridge 142. In addition, channel 154 includes an enlarged pump receiving cavity 178 that communicates with inlet 174. Pump receiving cavity 178 is adapted for receiving a pump therein. The pump may take the form of a rotatable impeller incorporating a bar of magnetically attractable material, e.g., a ferromagnetic stainless steel bar. Alternatively, the pump may take the form of a disc pump incorporating a ferromagnetic stainless steel bar (same dimensions and material as the one used as an impeller) embedded in a polymer disc fabricated from a material such as isoobornylacrylate (IBA). It is noted that the disc may by fabricated from a ferromagnetic material such that the disc rotates in response to ferromagnetic hysteresis or from a conductive material such that the disc rotates in response to electromagnetic induction. The impeller or disc is rotatably mounted on a support post in axial symmetry. Channel 154 further includes upstream port 180 and downstream port 182, for reasons hereinafter described.

Microfluidic platform 140 further includes first and second generally U-shaped capillary inserts 186 and 188, respectively. It can be appreciated that capillary inserts 186 and 188 may have other shapes without deviating from the scope of the present invention. Capillary inserts 186 and 188 include inner surfaces defining corresponding channels or passageways 190 and 192, respectively, therethrough. Capillary inserts 186 and 188 include first ends 194 and 196, respectively, and second ends 198 and 200, respectively, for reasons hereinafter described.

Upstream and downstream ports 168 and 170, respectively, in channel 152 may be fluidly connected by a flow droplet (hereinafter described) or by a generally U-shaped capillary insert generally designated by the reference numeral 202. It can be appreciated that capillary insert 202 may have other shapes without deviating from the scope of the present invention. Capillary insert 202 includes an inner surface defining a channel or passageway 204 therethrough. Capillary insert 202 includes first end 206 and second end 208, for reasons hereinafter described.

Upstream and downstream ports 180 and 182, respectively, in channel 154 may be fluidly connection by a generally U-shaped capillary insert (heretofore described) or by flow droplet generally designated by the reference numeral 210. Flow droplet 210 allows for the fluid flow in channel 154 continue from upstream port 180 into downstream port 182 through inner flow path 212 and provides an access point for selectively extracting or introducing fluid and/or particles out of or into channel 154.

In operation, channels 152 and 154 in cartridge 142 are filled with a first sample fluid. Similarly, passageways 190 and 192 though capillary inserts 186 and 188, respectively, are filled with corresponding second and third sample fluids, respectively. The first, second and third sample fluids may be identical or different. In addition, the first, second and third fluids may incorporate particles, molecules, cells or other biological or non-biological objects. Likewise, passageway 202 through capillary insert 202 is filed with a fourth sample fluid, either identical or different than the first, second and third sample fluids. Thereafter, first end 194 of capillary insert 186 is inserted into inlet 160 of channel 152 such that channel 152 communicates with a first end of passageway 190 through capillary insert 186. Second end 198 of capillary insert 186 is inserted into outlet 162 of channel 152 such that channel 152 communicates with a second end of passageway 190 through capillary insert 186.

In addition, first end 196 of capillary insert 188 is inserted into inlet 174 of channel 154 such that channel 154 communicates with a first end of passageway 192 through capillary insert 188. Second end 200 of capillary insert 188 is inserted into outlet 176 of channel 154 such that channel 154 communicates with a second end of passageway 192 through capillary insert 188. As described, capillary insert 186 connects inlet 160 and outlet 162 of channel 152 and capillary insert 188 connects inlet 174 and outlet 176 of channel 154.

First end 206 of capillary insert 202 is inserted into upstream port 168 of channel 152 such that channel 152 communicates with a first end of passageway 204 through capillary insert 202. Second end 208 of capillary insert 202 is inserted into downstream port 170 of channel 152 such that channel 152 communicates with a second end of passageway 202 through capillary insert 202. Finally, flow droplet 210 is deposited on upper surface 164 of cartridge 142 so as to overlap and communicate with upstream and downstream ports 180 and 182, respectively, of channel 154. The volume of flow droplet 210 may be regulated by the use of a computer controlled valve or the like. Flow droplet 210 provides inner flow path 212 from the fluid forming through channel 154. It can be understood that box 214 may be positioned about flow droplet 210 to isolate flow droplet 210 from the external environment and prevent evaporation and contamination thereof. As described, channels 152 and 154; passageways 190, 192 and 204; and inner flow path 212 define a closed loop and create a circulatory system.

In operation, a magnetic stirrer is activated thereby actuating the pumps in pump cavities 166 and 178. As a result, steady fluid flow is generated through the loop defined by channel 152 and passageways 190 and 202. In addition, steady fluid flow is generated through the loop defined by channel 154, passageway 192 and flow path 212. As heretofore described with respect to microfluidic platform 60, diffusion occurs at the interface the fluid streams flowing through portions 152a and 152a of channels 152 and 154, respectively. Once the fluids flowing in channels 152 and 154, passageway 190, 192 and 204, and flow path 212 have been re-circulated several times and a mixture has been formed, a selected capillary insert 186, 188 or 202 may be removed from cartridge 142. Thereafter, the selected capillary insert may be interconnected to a second cartridge, in the manner heretofore described, in order to analyze the sample or to perform a second reaction on the mixture.

It is further contemplated to extract sample fluid from or introduce sample fluid into the circulatory system of FIG. 6 through flow droplet 210. More specifically, referring to FIG. 8, box 214 is removed or opened so as to expose flow droplet 210. Thereafter, first and second pipettes 216 and 218, respectively, are inserted into flow droplet 210. First pipette 216 is used to extract a sample of the fluid flowing in channel 154. Second pipette 218 is used to introduce fluid into the fluid stream flowing in channel 154 to maintain the volume of fluid in the circulatory system of FIG. 6. If more fluid is added to channel 154 than is extracted, flow droplet 210 grows without disturbing the flow inside channel 154.

Various modes of carrying out the invention are contemplated as being within the scope of the following claims particularly pointing out and distinctly claiming the subject matter, which is regarded as the invention.

We claim:

1. A microfluidic platform for providing a closed loop fluid path, comprising:
a body defining a first channel therein, the first channel having an inlet and an outlet; and
a connector having a passageway therethrough, the passageway having a first end removeably receivable in the inlet of the first channel and a second end removeably receivable in the outlet of the first channel.

2. The microfluidic platform of claim 1 further comprising a pump disposed in the first channel, the pump movable between a first stationary position and a second operating position wherein the circulates fluid in the first channel and the connector.

3. The microfluidic platform of claim 2 wherein the first channel includes an enlarged portion for housing the pump.

4. The microfluidic platform of claim 2 wherein the pump includes a rotatable disc having a stir bar operatively connected thereto.

5. The microfluidic platform of claim 4 wherein the stir bar is fabricated from a magnetically attractable material such that the stir bar rotates the disc in response to a rotating magnetic field.

6. The microfluidic platform of claim 3 wherein the pump includes an impeller, the impeller rotatable in response to an external magnetic field.

7. The microfluidic platform of claim 1 wherein the body defines a second channel therein, the second channel having an inlet and an outlet and wherein the microfluidic platform further comprises a second connector having a passageway therethrough, the passageway of the second connector having a first end removeably receivable in the inlet of the second channel and a second end removeably receivable in the outlet of the second channel.

8. The microfluidic platform of claim 7 wherein the first and second channels in the body communicate with each other.

9. A microfluidic platform for providing a closed loop fluid path, comprising:
a body defining a first channel therein, the first channel having an inlet and an outlet and defining an enlarged pump cavity;
a pump disposed in the enlarged pump cavity, the pump rotating in response to a rotating magnetic field; and
a removable connector having a passageway therethrough, the passageway having a first end receivable in the inlet of the first channel and a second end receivable in the outlet of the first channel.

10. The microfluidic platform of claim 9 wherein the pump includes a rotatable disc having a stir bar operatively connected thereto.

11. The microfluidic platform of claim 10 wherein the stir bar is fabricated from a magnetically attractable material such that the stir bar rotates the disc in response to the rotating magnetic field.

12. The microfluidic platform of claim 9 wherein the pump includes an impeller, the impeller rotatable in response to the rotating magnetic field.

13. The microfluidic platform of claim 9 wherein the body defines a second channel therein, the second channel having an inlet and an outlet and wherein the microfluidic platform further comprises a second removable connector having a passageway therethrough, the passageway of the second connector having a first end receivable in the inlet of the second channel and a second end receivable in the outlet of the second channel.

14. The microfluidic platform of claim 13 wherein the first and second channels in the body communicate with each other.

15. A method of providing a closed loop, microfluidic circulatory system, comprising the steps of:
filling a first flow path with a first fluid, the first flow path having an inlet and an outlet;
filling a passageway extending through a first tube with a second fluid, the passageway having first and second ends;
interconnecting the first end of the passageway to the inlet of the first flow path and interconnecting the second end of the passageway to the outlet of the first flow path; and
pumping the first and second fluids through the first flow path and the passageway.

16. The method of claim 15 comprising the additional steps of:
filling a second flow path with a third fluid, the second flow path having an inlet and an outlet;
filling a passageway extending through a second tube with a fourth fluid, the passageway through the second tube having first and second ends;
interconnecting the first end of the passageway through the second tube to the inlet of the second flow path and interconnecting the second end of the passageway through the second tube to the outlet of the second flow path; and
pumping the third and fourth fluids through the second flow path and the passageway through the second tube.

17. The method of claim 16 wherein the first and second flow paths are formed in a body.

18. The method of claim of claim 16 wherein the first and second flow paths communicate.

19. The method of claim 15 wherein the step of pumping the first and second fluids through the first flow path and the passageway includes the additional step of mixing the first and second fluids, the mixed first and second fluids defining a mixture.

20. The method of claim 19 comprising the additional steps of:
filling a second flow path with a third fluid, the second flow path having an inlet and an outlet;
disconnecting the first end of the passageway from the inlet of the first flow path and disconnecting the second end of the passageway from the outlet of the second flow path, the passageway having the mixture therein; and
interconnecting the first end of the passageway to the inlet of the second flow path and interconnecting the second end of the passageway to the outlet of the second flow path.

21. The method of claim 20 comprising the additional step of pumping the third fluid and the mixture through the second flow path and the passageway.

22. The method of claim 19 wherein the first flow path includes a first downstream portion and a second upstream portion and wherein the method of the present invention comprises the additional step of interconnecting the upstream and downstream portions of the first flow path with a flow through droplet such that the mixture flows through the flow through droplet.

23. The method of claim 22 further comprising the additional step of removing a portion of the mixture flow through the flow through droplet.

24. The method of claim 22 further comprising the additional step of enclosing the flow through droplet.
